(19) United States
(12) Patent Application Publication
(10) Pub. No.: US 2014/0123430 A1
(43) Pub. Date: May 8, 2014

(54) WIPER BLADE DEVICE

(71) Applicants: Koen Bex, Jeuk/Limburg Belgien (BE); Helmut Depondt, Kessel-Lo (BE); Dirk Herinckx, Dries-Linter (BE)

(72) Inventors: Koen Bex, Jeuk/Limburg Belgien (BE); Helmut Depondt, Kessel-Lo (BE); Dirk Herinckx, Dries-Linter (BE)

(73) Assignee: Robert Bosch GmbH, Stuttgart (DE)

(21) Appl. No.: 14/130,301

(22) PCT Filed: May 29, 2012
(86) PCT No.: PCT/EP2012/059976

§ 371 Date: Dec. 30, 2013

(30) Foreign Application Priority Data
Jun. 28, 2011 (DE) 10 2011 078 163.3

(51) Int. Cl. B60S 1/38

(52) U.S. Cl. CPC B60S 1/3879; B60S 1/3889
USPC 15/250.361

(57) ABSTRACT

The invention relates to a wiper blade device comprising at least one spring strip (10) and at least one end sealing unit (12). According to the invention, in order to fix the spring strip (10), the end sealing unit (12) has at least one detent element (18) which is rendered flexible by means of an inner cavity (14) in an element (16) of said end sealing unit (12).

### BACKGROUND OF THE INVENTION

The invention starts from a wiper blade device.

A wiper blade device of a wiper blade for use on a motor vehicle is already known, comprising at least one spring strip and two end termination units. The end termination units are arranged at two ends of the spring strip.

### SUMMARY OF THE INVENTION

The invention starts from a wiper blade device having at least one spring strip and at least one end termination unit.

It is proposed that, in order to fasten the spring strip, the end termination unit has at least one latching element, which is created from an element of the end termination unit by means of an inner aperture. The term “spring strip” is intended, in particular, to mean a component part which has at least one extent that can be changed elastically in a normal operating state by at least 10%, in particular by at least 20%, preferably by at least 30%, and particularly advantageously by at least 50%, and that, in particular, produces a counterforce dependent on a change in the extent, which counterforce counteracts the change. In this context, the term “extent” of an element is intended, in particular, to mean a maximum distance between two points of a perpendicular projection of the element onto a plane. The spring strip is preferably of integral design. The term “integral” is intended, in particular, to mean materially connected, e.g. by means of a welding process and/or an adhesive bonding process etc., and particularly advantageously to mean formed on, as by being produced from a single molding and/or by being produced in a single- or multi-component injection molding process. The spring strip is preferably of elongate design. The spring strip is preferably composed at least partially of spring steel. In an unloaded state, the spring strip preferably has essentially the shape of a bent bar and, as a particularly advantageous possibility, of a flattened bent bar. As a particularly advantageous possibility, a curvature of the spring strip along a longitudinal extent in an unloaded state is greater than a curvature of a vehicle surface of a motor vehicle, in particular of a vehicle window over which the spring strip is guided in at least one operating state. The spring strip preferably has a latching element, in particular an aperture, which is in operative connection with at least one of the latching elements of the end termination unit in an assembled state. Here and below, the term “aperture” is intended, in particular, to mean an aperture in the material of a component extending, in particular, from a first surface of the component to an opposite second surface of the component.

In this context, the term “end termination unit” is intended, in particular, to mean a unit which is provided for the purpose of being fastened on one end of the spring strip. In particular, the end termination unit is provided for the purpose of providing an end termination for a wiper blade comprising the wiper blade device in an assembled state. The end termination unit is preferably formed at least partially by a plastic. The end termination unit is preferably designed as an end cap, which engages around part of the spring strip, especially in at least one assembled state. The wiper blade device preferably comprises just two end termination units, one for each end of the spring strip. The term “inner aperture” is intended, in particular, to mean an aperture which, during the notional insertion of a bar of infinite length and of any thickness in a direction of introduction, prevents removal of the bar perpendicularly to the direction of introduction. The term “latching element” is intended, in particular, to mean an element which is provided for the purpose of producing a latching connection in interaction with a further latching element. The latching element is preferably embodied as a latching hook which, in particular, has a partial area that is moved in a direction perpendicular to the spring strip during a latching operation and/or changes an extent in a direction perpendicular to the spring strip. In this context, a direction “perpendicular to the spring strip” is intended, in particular, to mean a direction perpendicular to a longitudinal extent of the spring strip. In this context, “latching element created from an element” is intended, in particular, to mean a latching element which is formed from the element by means of an aperture, in particular the inner aperture. An elastically deflectable region is preferably created from the element by means of the inner aperture.

By means of such an embodiment, it is advantageously possible to provide a stable end termination unit having a latching element in a manner which is simple in terms of design. Moreover, simple and convenient mounting of the end termination unit on the spring strip is made possible.

In a preferred embodiment of the invention, it is proposed that the end termination unit has a panel that forms the element. In this context, the term “panel” of the end termination unit is intended, in particular, to mean a component part which extends from one side region of the end termination unit to an opposite side region of the end termination unit. In this context, a “side region of the end termination unit” is intended, in particular, to mean a spatial region of the end termination unit which is arranged next to the spring strip in an assembled state. Here, the statement that a spatial region is arranged “next to the spring strip” is intended, in particular, to mean that an infinite extension of the spring strip in the direction of an axis of curvature intersects the spatial region. The term “axis of curvature” of the spring strip is intended, in particular, to mean an axis which is perpendicular to an arbitrary surface normal of a largest smooth surface of the spring strip. The panel is preferably an intermediate panel of the end termination unit. It is thereby possible to increase the stability of the end termination unit.

In a particularly preferred embodiment of the invention, it is proposed that a partial area of the element is provided for the purpose of being twisted as the spring strip is mounted on the end termination unit. Any twisting of the partial area is preferably reversible. It is thereby possible to produce an advantageously large restoring force for the latching element.

If the element is formed integrally on the end termination unit, advantageously simple production of the end termination unit with the element is made possible. The end termination unit is preferably produced together with the element as a single molding. The latching element is preferably cut out of the element.

It is furthermore proposed that the spring strip has at least one latching aperture for fastening the end termination unit. The term “latching aperture” is intended, in particular, to mean an aperture which interacts with a latching element, preferably a latching hook, to form a latching connection. The latching aperture is preferably designed as an inner aperture. It is thereby possible to enable an advantageously simple and low-cost design of the spring strip.

In another embodiment of the invention, it is proposed that the wiper blade device comprises a wiper strip support, which has a receiving region for holding a wiper strip. A “wiper strip” is intended, in particular, to mean a unit which has a wiper lip and a holding region for holding the wiper lip on a wiper strip support. In this context, the term “wiper lip” is intended to mean an element of the wiper blade device which is moved over the vehicle surface, in particular the vehicle window, during operation of the wiper blade device, preferably touching the surface during a complete movement and, as a particularly advantageous possibility, being pressed as uniformly as possible against the vehicle surface, in particular by the spring strip. The wiper lip is preferably of integral design and is preferably composed of a natural rubber and, as a particularly advantageous possibility, of a synthetic rubber. The term “wiper strip support” is intended, in particular, to mean a unit which is provided for the purpose of fastening the wiper strip on the spring strip. The wiper strip support is preferably distinct from a spring strip and is designed as a separate component. The wiper strip support is preferably composed at least partially of rubber and/or of an at least partially flexible plastic. The receiving region is preferably provided for the purpose of receiving and fastening the holding region of the wiper strip. It is thereby possible to provide secure retention of the wiper strip on the spring strip. If the wiper strip support additionally has a receiving region for the purpose of retaining a spoiler unit, it is furthermore also possible to achieve secure retention of the spoiler unit on the spring strip. In this context, the term “spoiler unit” is intended, in particular, to mean a unit which is provided for the purpose of deflecting a relative wind acting on the wiper blade device and/or of using said wind to press the wiper lip onto the vehicle surface. The spoiler unit is preferably composed at least partially of rubber and/or of an at least partially flexible plastic.

It is furthermore proposed that the end termination unit has a receiving region for the wiper strip, continuing the receiving region of the wiper strip support in an assembled state. It is thereby advantageously possible to achieve secure retention of the wiper strip, especially in an end region of the wiper blade.

### BRIEF DESCRIPTION OF THE DRAWINGS

Further advantages will become apparent from the following description of the drawing. The drawing shows an illustrative embodiment of the invention. The drawing, the description and the claims contain numerous features in combination. A person skilled in the art will expediently also consider the features individually and combine them into worthwhile further combinations.

In the drawing:

FIG. 1 shows a wiper blade having a wiper blade device in a schematic illustration,

FIG. 2 shows the wiper blade device in a section along a line II-II in FIG. 1,

FIG. 3 shows the end termination unit of the wiper blade device in a sectional view,

FIG. 4 shows the end termination unit and a spring strip of the wiper blade device in an isometric sectional view obliquely from below,

FIG. 5 shows the spring strip in a plan view,

FIG. 6 shows the end termination unit and the spring strip in another sectional view,

FIG. 7 shows the end termination unit, the spring strip and a wiper strip support in an isometric sectional view obliquely from below, and

FIG. 8 shows the wiper blade device in a sectional view along a line VIII-VIII in FIG. 2.

### DETAILED DESCRIPTION

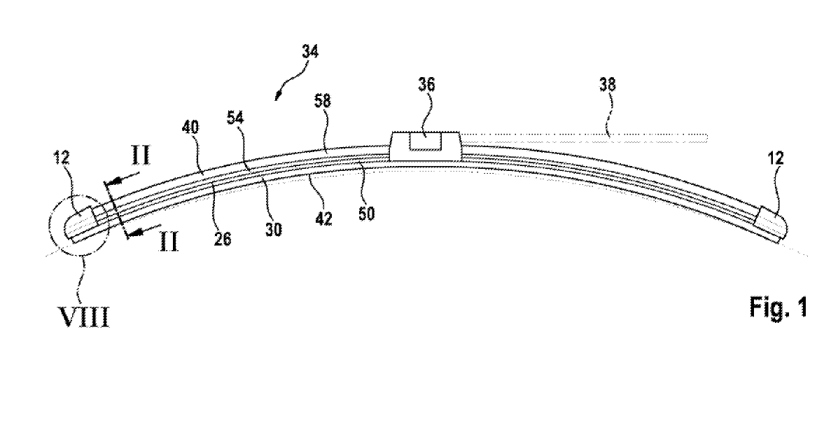

FIG. 1 shows schematically a wiper blade 34 having a wiper blade device according to the invention. The wiper blade 34 has an adapter 36, which is provided for mounting the wiper blade 34 on a wiper arm 38, depicted in dashed lines, of a window wiper system of a motor vehicle.

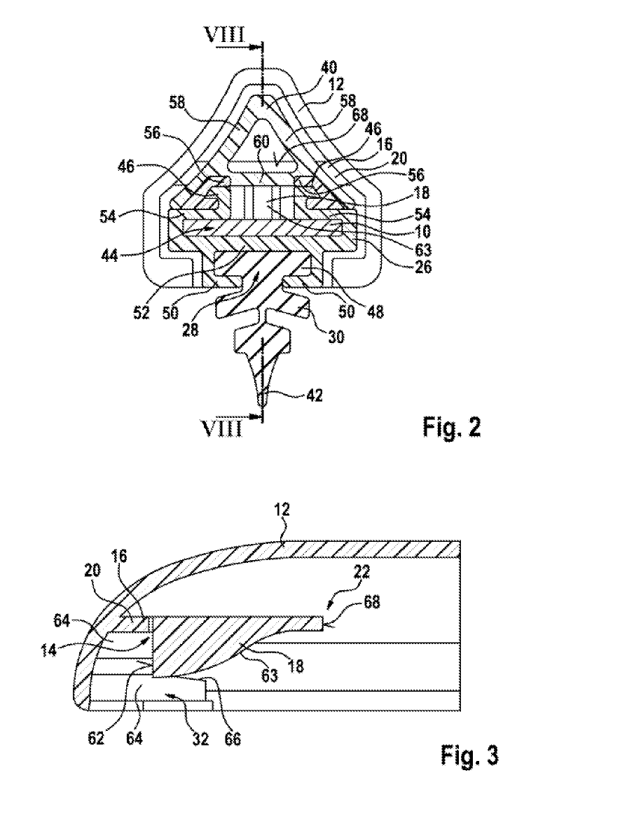

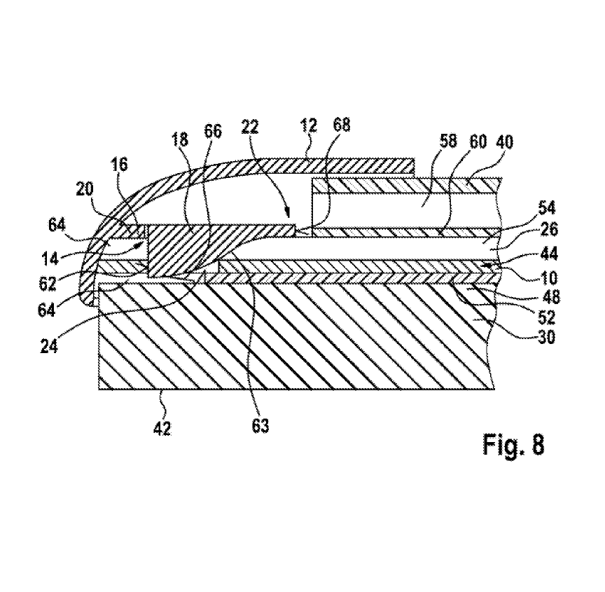

FIG. 2 shows the wiper blade device in a sectional view along a line II-II in FIG. 1. The wiper blade device comprises a spring strip 10 of spring steel extended lengthwise in the form of a strip and curved. The wiper blade device furthermore has a wiper strip support 26 composed of a flexible plastic, a wiper strip 30 composed of a synthetic rubber, and a spoiler unit 40 composed of a partially flexible plastic. As can be seen from FIG. 1, the wiper strip support 26, the wiper strip 30 and the spoiler unit 40 are of elongate design and are arranged parallel to the spring strip 10 in an assembled state. The spring strip 10 is provided for the purpose of pressing a wiper lip 42 of the wiper strip 30 in a largely uniform manner against a surface to be wiped during operation of the window wiper system. For this purpose, a curvature of the spring strip 10 is designed in such a way that, in an unloaded state, it is greater than a maximum curvature occurring on the surface to be wiped. The wiper strip support 26 is provided for the purpose of connecting the wiper strip 30 securely to the spring strip 10 and transmitting any side forces which occur during wiping from the wiper strip 30 to the spring strip 10. The spoiler unit 40 ensures an increased contact pressure of the wiper blade 34 on the surface and prevents the wiper blade 34 from lifting off from the surface owing to the relative wind when the motor vehicle is moving quickly. The wiper blade 34 is closed off at both ends by an end termination unit 12 of the wiper blade device. In this arrangement, the end termination unit 12, which is designed as an end cap, in each case receives end regions of the spring strip 10, of the wiper strip support 26 and of the spoiler unit 40 (cf. FIG. 8).

According to FIG. 2, the wiper strip support 26 has an at least substantially H-shaped form when viewed in cross section. When viewed in cross section, ends of the wiper strip support 26 are bent around to form receiving regions 28, 44 and holding strips 46. Receiving region 28 is provided to receive a holding element 48 of the wiper strip 30. Receiving region 44 is provided to receive the spring strip 10. The holding strips 46 are provided for holding the spoiler unit 40. Receiving region 28 is formed on a part of the H-shaped cross section of the wiper strip support 26 which faces the wiper strip 30. When viewed in cross section, lower H legs 50 of the wiper strip support 26 which face the wiper strip 30 are bent around toward one another. In an end region, the lower H legs 50 of the wiper strip support 26 are aligned parallel to one another and parallel to an H beam 52. A cavity open in the direction of the wiper strip 30 is thereby formed, into which cavity the holding element 48 of the wiper strip 30 fits positively. Receiving region 44 and the holding strips 46 are formed on a part of the H-shaped cross section of the wiper strip support 26 which faces the spoiler unit 40. From the H beam 52, the upper H legs 54, which face the spoiler unit 40, initially extend outward on both sides parallel to the H beam 52 and are then bent over at right angles in a direction toward the spoiler unit 40. After covering a distance corresponding to the thickness of the spring strip 10, the upper H legs 54 are once again bent over at right angles, more specifically toward one another. After covering a further distance, the upper H legs 54 are once again redirected through 90° in a direction away from the H beam 52. After covering a further distance, the upper H legs 54 are bent over outward at right angles in a direction away from a center of gravity of the area of the cross section of the wiper strip support 26. A cavity open toward the spoiler unit 40 is formed directly above the H beam 52, into which cavity the spring strip 10 fits positively. The folded-over ends of the upper H legs 54 form the holding strips 46, which engage in corresponding holding grooves 56 of the spoiler unit 40.

When viewed in cross section, the spoiler unit 40 has at least substantially the form of an isosceles triangle (cf. FIG. 2). Triangle sides 58 of the triangle are extended beyond a base side 60 of the triangle and there have the holding grooves 56. In a region of the holding grooves 56, the spoiler unit 40 is composed of a harder plastic in comparison with the remaining regions of the spoiler unit 40. It is thereby possible to ensure secure retention of the holding grooves 56 on the holding strips 46 of the wiper strip support 26. There is furthermore the possibility of simplifying the pushing of the spoiler unit 40 onto the wiper strip support 26 during assembly of the wiper blade 34. To improve the wind guiding properties of the triangle sides 58, they have a slightly concave curvature when viewed from the outside.

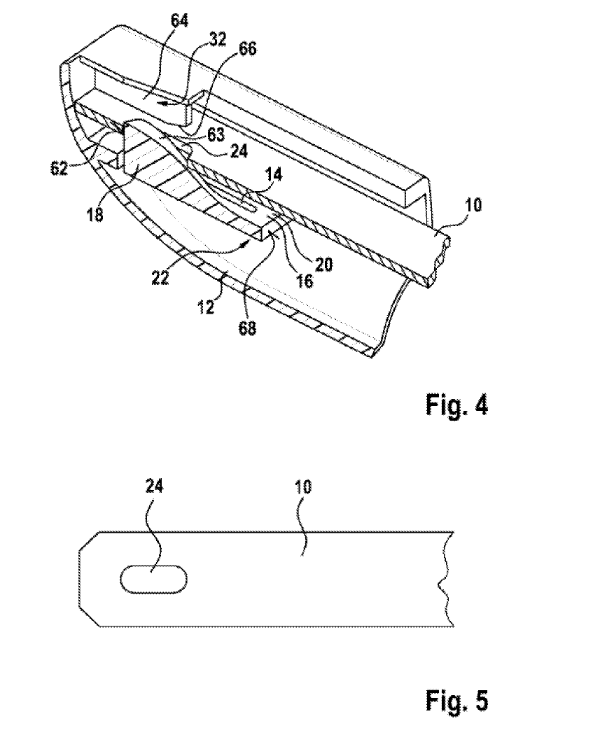

FIG. 3 shows the end termination unit 12 in an unassembled state in a sectional view from the side. The end termination unit 12 is composed of an at least partially flexible plastic. For fastening the spring strip 10, the end termination unit 12 has a latching element 18 created from an element 16 by means of an inner aperture 14. In this case, the element 16 is formed by a panel 20, more specifically by an intermediate panel of the end termination unit 12. The element 16 is formed integrally on the end termination unit 12. When viewed perpendicularly to a principal plane of extent of the element 16, the inner aperture 14 is at least substantially U-shaped (cf. FIG. 4). In an assembled state, ends of the U-shaped inner aperture 14 point in the direction of a center of gravity of the spring strip 10. The element 16 comprises a partial area 22 which is provided for the purpose of being twisted as the spring strip 10 is mounted on the end termination unit 12. The partial area 22 is arranged on two ends of the U-shaped inner aperture 14. Twisting the partial area 22 produces a restoring force on the latching element 18. In a direction away from the partial area 22, on a side provided for mounting the wiper strip 30, the latching element 18 is thickened, giving rise to a latching surface 62 which faces one end of the spring strip 10 in an assembled state. A surface normal of the latching surface 62 is substantially parallel to a principal plane of extent of the spring strip 10 in an end region. On a side facing away from the latching surface 62, the latching element 18 has a run-on bevel 63. In an assembled state, the run-on bevel 63 has a shallower angle to the principal plane of extent of the spring strip 10 in a first and a third partial area in the end region than in a second partial area situated between the first and the third partial area. On a side which faces away from the wiper strip 30 in an assembled state, the element 16 is of flat design.

FIG. 4 shows the end termination unit 12 with the spring strip 10 mounted in an isometric sectional view obliquely from below, wherein the wiper strip support 26, the wiper strip 30 and the spoiler unit 40 are not shown in FIG. 4 for the sake of greater clarity. Once the latching connection has been established, the latching element 18 engages in a latching aperture 24 in the spring strip 10 (cf. FIG. 5). As the spring strip 10 is introduced into the end termination unit 12, partial area 22 of the element 16 is twisted. Once the spring strip 10 has been pushed in far enough, the latching element 18 latches into the latching aperture 24. The spring strip 10 is prevented from being pulled out since the latching surface 62 of the latching element 18 interacts with a corresponding surface bounding the latching aperture 24 and forms a stop once the latching connection has been established. In this way, it is possible to achieve reliable latching of the end termination unit 12 with the wiper strip 10.

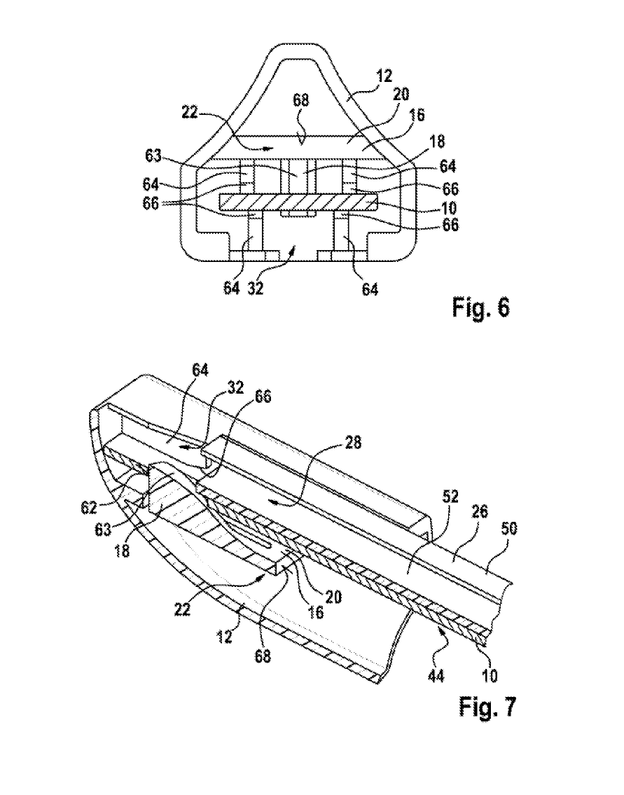

FIG. 6 shows the end termination unit 12 with the spring strip 10 mounted in another sectional view, wherein the wiper strip support 26, the wiper strip 30 and the spoiler unit 40 are not shown in FIG. 6 for the sake of greater clarity. A position of the spring strip 10 relative to the end termination unit 12 perpendicular to the principal plane of extent of the element 16 is defined by holding webs 64. The holding webs 64 are formed integrally on the end termination unit 12. To facilitate mounting the spring strip 10 on the end termination unit 12, the holding webs 64 each have a run-on bevel 66 on a side facing the center of gravity of the spring strip 10.

FIG. 7 shows the end termination unit 12 with the spring strip 10 mounted and the wiper strip support 26 mounted in an isometric sectional view obliquely from below, wherein the wiper strip 30 and the spoiler unit 40 are not shown in FIG. 7 for the sake of greater clarity. The end termination unit 12 has a receiving region 32 for the wiper strip 30, which region continues the receiving region 28 of the wiper strip support 26, once the latching connection has been established. It is thereby possible to ensure secure retention of the wiper strip 30 in an end region of the wiper blade 34 too.

FIG. 8 shows the wiper blade device in a sectional view along a line VIII-VIII in FIG. 2. A position of the spoiler unit 40 parallel to the spring strip 10 is defined by abutment of the spoiler unit 40 against an end face 68 of the element 16, which face faces the spoiler unit 40. In an inner region, the end termination unit 12 is shaped in such a way that the wiper strip support 26 with the spoiler unit 40 mounted thereon fits positively into the end termination unit 12 (cf. FIG. 2). Use can be made here, in particular, of additional spacer webs of the kind indicated in FIGS. 2 and 8, in particular, by spacings shown between the end termination unit 12 and the wiper strip support 26 and between the end termination unit 12 and the spoiler unit 40. The spacer webs can be provided, in particular, to compensate for manufacturing and/or assembly tolerances.

1. A wiper blade device having at least one spring strip (10) and at least one end termination unit (12), characterized in that, the spring strip (10) is fastened to the end termination unit (12) by at least one latching element (18) on the end termination unit, the latching element being created from a second element (16) of the end termination unit (12) by means of an inner aperture (14).

2. The wiper blade device as claimed in claim 1, characterized in that the end termination unit (12) has a panel (20) that forms the element (16).

3. The wiper blade device as claimed in claim 12, characterized in that a partial area (22) of the element (16) is twisted as the spring strip (10) is mounted on the end termination unit (12).

4. The wiper blade device as claimed in claim 1, characterized in that the second element (16) is formed integrally on the end termination unit (12).

5. The wiper blade device as claimed in claim 1, characterized in that the spring strip (10) has at least one latching aperture (24) for fastening the end termination unit (12).

6. The wiper blade device as claimed in claim 1, characterized by a wiper strip support (26), which has a receiving region (28) for holding a wiper strip (30).

7. The wiper blade device as claimed in claim 6, characterized in that the end termination unit (12) has a receiving region (32) for the wiper strip (30), continuing the receiving region (28) of the wiper strip support (26) in an assembled state.

8. A wiper blade (34) having a wiper device as claimed in claim 1.

9. An assembly of a spring strip (10) and an end termination unit (12) of a wiper blade device as claimed in claim 1.

10. A wiper strip support (26) of a wiper blade device as claimed in claim 6.

11. The wiper blade device as claimed in claim 6 further comprising a wiper strip held by the wiper strip support.

12. The wiper blade device as claimed in claim 3, characterized in that the second element (16) is formed integrally on the end termination unit (12).

13. The wiper blade device as claimed in claim 12, characterized in that the spring strip (10) has at least one latching aperture (24) for fastening the end termination unit (12).

14. The wiper blade device as claimed in claim 13, characterized by a wiper strip support (26), which has a receiving region (28) for holding a wiper strip (30).

15. The wiper blade device as claimed in claim 14, characterized in that the end termination unit (12) has a receiving region (32) for the wiper strip (30), continuing the receiving region (28) of the wiper strip support (26) in an assembled state.

16. The wiper blade device as claimed in claim 15 further comprising a wiper strip held by the wiper strip support.
